(19) United States
(12) Patent Application Publication
(10) Pub. No.: US 2004/0264386 A1
(43) Pub. Date: Dec. 30, 2004

(54) Communication integration system for establishing fittest communication route depending on information of user's communication terminals and calling method using the same

(76) Inventor: Kyung-Lim Ha, Seoul (KR)

Correspondence Address: JONES DAY, 222 EAST 41ST ST, NEW YORK, NY, 10017, US

(21) Appl. No.: 10/494,812

(22) PCT Filed: Nov. 1, 2002
(86) PCT No.: PCT/KR02/02037

(30) Foreign Application Priority Data
Nov. 6, 2001 (KR) 1020010068711

(51) Int. Cl. H04L 12/28

(52) U.S. Cl. 370/254; 370/252

(57) ABSTRACT

A calling method using a communication integration system, which has a CIS server configuring a cell bound in connection of plural communication means and plural communication networks and a relay server connected to at least two CIS servers, includes the steps of: (a) transmitting a fittest communication route calculation request signal from the CIS server to the relay server; (b) the relay server calculating a fittest communication route between users based on a predetermined weight according to the request signal and then providing the fittest communication route to the CIS server; and (c) the CIS server connecting a call between communication terminals of the users.

### TECHNICAL FIELD

The present invention relates to Computer and Telephony Integration (CTI), and more particularly to a communication integration system for setting and connecting a fittest communication route among many routes which can be established between a caller and a receiver by owning communication information depending on a location of a user in common, and a method for establishing such a communication route.

### BACKGROUND ART

Nowadays, mobile communication and Internet have been developed remarkably. Mobile communication enables a user to communicate during movement with the use of roaming and handoff functions by dividing micro frequency into each cell on the basis of wireless communication. Presently, various services for the mobile communication are developed and provided, for example WAP or I-mode for giving wireless Internet service together with voice service through a mobile communication terminal. In addition, video service is scheduled under IMT-2000 circumstance.

As communication circumstance changes, users may have more chances to select communication terminals: e.g., a general wired phone, a mobile phone and an Internet phone. Accordingly, communication routes between a caller and a receiver are more diversified. Examining the present status of each communication provider in South Korea at 2001, there are registered totally 26 service providers: four local phone service providers, four national phone service providers, four international phone service providers, five mobile phone service providers, two satellite mobile/data communication service providers, and seven Trunked Radio System (TRS) service providers. In the aspect of communication routes, it is assumed that there may be 676 (=26×26) communication routes in such circumstance.

FIG. 1 shows an example of various communication networks. Such communication networks generally include PSTN used by wired telephones and facsimiles most commonly; a wireless communication network having a mobile communication network used by cellular phones, PCS and TRS, DSRC (Dedicated Short-Range Communication) used by Bluetooth, Wi-Fi and wireless LAN for local wireless communication, and LMDS (Local Multi-point Distribution Service) used by WLL (Wireless Local Loop) and wireless CATV for wireless connection of a fixed communication terminal; a satellite communication network used by SNG (Satellite News Gathering), GPS (Global Positioning System), satellite base stations and satellite phones; and a communication network through Internet used by PCs and Internet phones.

A user may select a suitable communication route among them as required, and the selection is generally based on convenience and economical efficiency.

A certain communication service provider requires a user to push identification numbers for the corresponding service provider before pushing a phone number of the called, which is very inconvenient and becomes one of main factors to lose coefficient of utilization of the communication network.

Users tend to interest in cheaper communication networks. For example, a callback service is one way of using a communication network cheaper. The callback service is mainly used to try a call at a cheaper site when international call charges are different. In the callback service, if a caller makes a call to a receiver and then rings off before the receiver answers the telephone in order to make an incomplete call intentionally, a callback service provider makes a call through a cheaper communication route and then hooks off the call so that the caller and the receiver can be connected through the route. At the present, many improved systems using Local Node Callback service or Call-Through service are introduced for supporting such a callback service. However, to establish a fittest communication route considering all communication networks existing between the caller and the receiver is still impossible.

For example, in case a caller and a receiver may be equipped with a wired phone, a mobile phone and an Internet phone, the call charge between them can be cheapest using the Internet phone. In addition, depending on current locations of the caller and the receiver, the callback service might be more advantageous. However, a caller, a receiver or even a communication service provider for connecting them cannot verify which communication terminal the opponent or the users presently possess and which communication network they are accessible. Thus, without such information, it is impossible to determine a fittest communication route.

### DISCLOSURE OF INVENTION

The present invention is designed to solve such problems of the prior art, and therefore an object of the invention is to provide an communication integration system for establishing a fittest communication route through communication terminals accessible to the user on the basis of location of the user which is verified in real time, and a calling method using the system.

According to the present invention, a caller needs not to verify which communication terminal a receiver possesses and which communication network is most advantageous, and the communication integration system of the present invention automatically establishes a fittest communication route in accordance with a predetermined standard desired by the user.

In order to accomplish the above object, the present invention provides a calling method using a communication integration system including CIS servers configuring a cell bound in connection with a plurality of communication terminals and a plurality of communication networks and a relay server connected to at least two CIS servers, the method comprising the steps of (a) transmitting a fittest communication route calculation request signal from the CIS server to the relay server; (b) the relay server calculating a fittest communication route between users on the basis of a predetermined weight according to the request signal and then providing the fittest communication route to the CIS server; and (c) the CIS server performing call connection between the communication terminals of the users according to the calculated fittest communication route.

Preferably, the user registers communication terminal information of the user in the relay server by using a personal terminal.

According to another embodiment of the present invention, an identifier reader for reading a user identifier including an ID card, a fingerprint and an iris of the user is installed in the cell bound in which the CIS server is positioned, and the calling method further comprises the steps of checking that the user enters into the cell bound by using the identifier reader and then transmitting the information from the CIS server to the relay server; and the relay server searching communication terminal information of the user from the user information DB previously. registered according to the received information and then registering the communication terminal information.

According to still another embodiment of the present invention, the calling method further includes the steps of the user making a mobile communication terminal access the CIS server; the CIS server checking peculiar information of the accessed mobile communication terminal and then transmitting the peculiar information to the relay server; and the relay server searching communication terminal information of the user from the user information DB previously registered according to the received peculiar information and then registering the information.

Preferably, the communication terminal is at least one selected from a wired extension phone using PBX, a mobile communication terminal and a satellite phone.

According to another aspect of the present invention, there is provided a calling method using a communication integration system including CIS servers configuring a cell bound in connection with a plurality of communication terminals and a plurality of communication networks and a relay server connected to at least two CIS servers, which includes the steps of (a′) a caller, who belongs to in one cell bound, inputting a phone number of one of the communication terminals of a receiver, who belongs to another cell bound, by use of one of the communication terminals, and then attempting a call; (b′) the caller CIS server transmitting fittest communication route request information including the input phone number to the relay server; (c′) the relay server calculating a fittest communication route between the caller and the receiver on the basis of a weight determined by searching user information, CIS server information and communication terminal information which are previously registered, and then transmitting the fittest communication route to the caller CIS server; (d′) the caller CIS server sending a call signal to the communication terminal of the receiver along the received fittest communication route; and (e′) connecting a call between the caller and the receiver when the receiver answers the call signal.

Preferably, the step (e′) includes the steps of transmitting the call signal, transmitted from the caller CIS server and then received in the communication terminal of the receiver, to the receiver CIS server; and the receiver CIS server switching the received call signal into a wired extension phone of the receiver to connect a call.

More preferably, the call between the caller and the receiver may be connected via a substitutive communication terminal of other user provided in the cell bound to which the caller and the receiver belong.

In addition, the calling method of the present invention preferably includes the steps of the relay server determining whether the communication terminal of the receiver is usable from receiver communication terminal information; the relay server searching substitutive communication terminals of other users belonging to the receiver cell bound from user information DB and CIS information DB when the communication terminal of the receiver is not usable; the relay server transmitting fittest communication route information including information about the substitutive communication terminal to the caller CIS server and at the same time transmitting identifying information to the receiver CIS server; the caller CIS server sending a call signal to the substitutive communication terminal according to the fittest communication route information; transmitting the call signal received by the substitutive communication terminal to the receiver CIS server; the receiver CIS server identifying a calling phone number from the received call signal according to the identifying information; and connecting a call to the corresponding receiver according to the identified calling phone number.

According to still another aspect of the present invention, there is also provided a calling method using a communication integration system including a CIS server configuring a cell bound in connection with a plurality of communication terminals and a plurality of communication networks and a relay server connected to the CIS server, which includes the steps of (a″) a caller, who does not belong to the cell bound, inputting a phone number of one of the communication terminals of a receiver who belongs to the cell bound, and then sending a call signal; (b″) transmitting the call signal received by the communication terminal of the receiver to the CIS server; (c″) the CIS server transmitting fittest communication route request information including a phone number of the caller to the relay server; (d″) the relay server calculating a backward fittest communication route from the receiver communication terminal to the caller communication terminal according to a weight based on a call charge by searching user information and communication terminal information which are previously registered; (e″) determining whether a call charge of the fittest communication route is cheaper than that of a communication route forwarding from the caller to the receiver, and then if so, the relay server transmitting a callback request signal to the CIS server; (f″) the CIS server, which receives the callback request signal, concluding the call received from the caller; (g″) the CIS server, which concludes the call, sending a call signal to the communication terminal of the caller; and (h″) the CIS server connecting a call between the caller and the receiver when the caller answers the call signal.

Preferably, the step of concluding a call includes the steps of receiving a call signal of the caller in the receiver communication terminal; providing a guidance message from the CIS server to the caller communication terminal; and concluding the call after the caller receives the guidance message.

According to further another aspect of the present invention, there is also provided a communication integration system, which includes a CIS server connected to a plurality of communication terminals and a plurality of communication networks to configure a cell bound and performing call connection through the networks; and a relay server connected to at least two CIS servers to own information of the communication terminals connected to the CIS servers in common, wherein, when the CIS server transmits a fittest communication route calculation request to the relay server, the relay server calculates and provides a fittest communication route between a caller and a receiver on the basis of a weight predetermined by a communication route calculating unit and then the CIS server performs call connection between the communication terminals along the calculated fittest communication route.

The CIS server may include a main controller for controlling each component; a switching unit for connecting or disconnecting a call signal input to or output from the CIS server according to communication terminals; a call identifying unit for receiving the call signal received in the communication terminal from outside and then identifying a calling phone number; a signal transforming unit for transforming and outputting the input/output call signal to be agreeable to the connected communication terminal; and a signal transmitting/receiving unit for transmitting a call signal to outside along the fittest communication route and receiving a call signal from outside.

Preferably, the relay server includes an information providing unit for transmitting and providing user information to a personal terminal connected to Internet so that a user in the cell bound may check information of the opponent during conversation.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic diagram showing various communication networks and communication terminals, as an example;

FIG. 2 is a schematic diagram showing an overall network hierarchy based on cell bound according to a preferred embodiment of the present invention;

FIG. 3 is a schematic diagram showing the cell bound according to a preferred embodiment of the present invention;

FIG. 4 is a block diagram showing a CIS server according to a preferred embodiment of the present invention;

FIG. 5 is a block diagram showing a relay server according to a preferred embodiment of the present invention;

FIGS. 6a, 6b, 6c and 6d are tables, which exemplarily show a phone number system DB, a user information DB, a voice information DB and a call specification DB of the CIS server according to a preferred embodiment of the present invention, respectively;

FIGS. 7a, 7b, 7c, 7d and 7e exemplarily show a user information DB, a CIS server information DB, a communication terminal DB, a call charge DB and an imposing specification DB of the relay server according to a preferred embodiment of the present invention, respectively;

FIG. 8a is a flow chart for illustrating the process of registering and updating communication terminal information of a user by use of a personal terminal such as a PC or a notebook according to a preferred embodiment of the present invention;

FIG. 8b is a flow chart for illustrating the process of registering and updating communication terminal information of a user by use of a user identifier such as an ID card, a fingerprint or an iris according to a preferred embodiment of the present invention;

FIG. 8c is a flow chart for illustrating the process of registering and updating communication terminal information of a user by us of a mobile communication terminal such as a cellular phone according to a preferred embodiment of the present invention;

FIG. 9 is a block diagram for illustrating the calling process between cell bounds according to a preferred embodiment of the present invention;

FIG. 10 is a flow chart for illustrating the calling process between cell bounds according to a preferred embodiment of the present invention;

FIG. 11a is a flow chart linked to the flow chart of FIG. 10 for illustrating the calling process through a forward fittest communication route;

FIG. 11b is a flow chart linked to the flow chart of FIG. 11a for illustrating the calling process through a backward fittest communication route;

FIG. 12 is a flow chart linked to the flow chart of FIG. 10 for illustrating the calling process in case a speech quality is a weight;

FIG. 13 is a flow chart linked to the flow chart of FIG. 10 for illustrating the calling process in case a communication stability is a weight;

FIG. 14 is a flow chart for illustrating the calling process by using a communication terminal substituted for the user's communication terminal; and

FIGS. 15a and 15b are flow charts for illustrating the process for a caller not belonging to a cell bound to make a call to a receiver belonging to the cell bound according to a preferred embodiment of the present invention.

### BEST MODES FOR CARRYING OUT THE INVENTION

1. A Network for a Communication Integration Service System

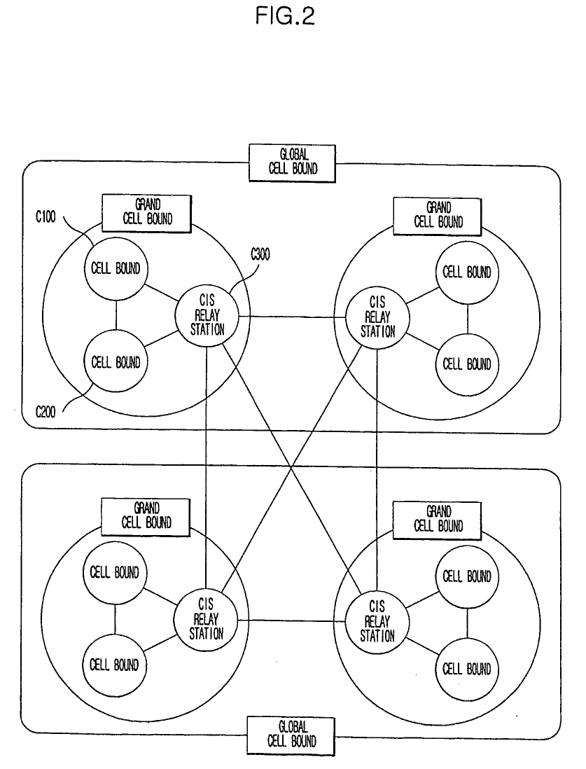

FIG. 2 shows a network for a communication integration system according to the present invention. Referring to FIG. 2, a user using the communication integration system belongs to a ‘Cell Bound’. The cell bound C100 or C200 is a unit communication region in which at least two communication terminals are connected to one Communication Integration System (hereinafter, referred to as ‘CIS’).

These cell bounds C100 and C200 are connected to a CIS relay station C300 and own location information and communication terminal information of users in common, as described later.

The CIS relay station C300 is connected to a CIS server belonging to the cell bound through a network to collect location information of users in real time and then provide a fittest communication route on the basis of the location information.

As shown in the figure, the cell bounds C100 and C200 are connected to the CIS relay station C300 and configure one grand cell bound, which is connected to a neighboring grand cell bound to configure a global cell bound. Now, a detailed configuration of the cell bound is described.

2. A Cell Bound

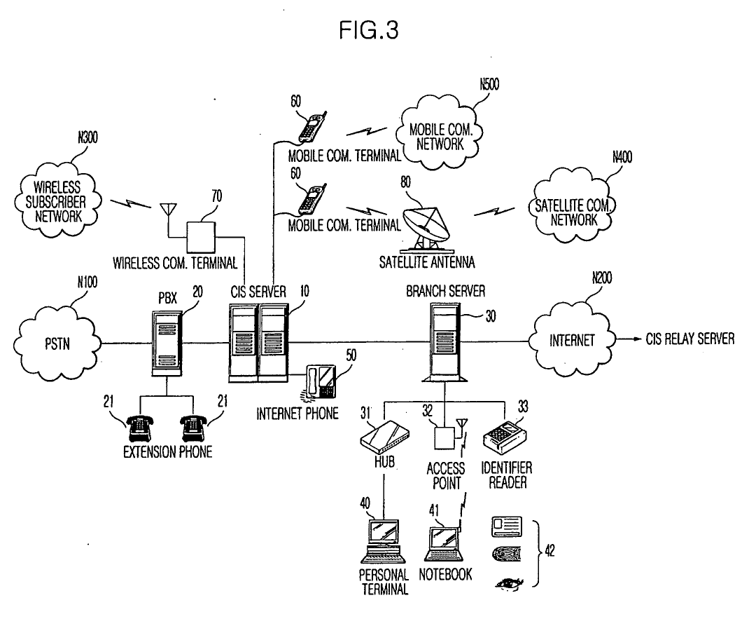

FIG. 3 schematically shows a cell bound according to a preferred embodiment of the present invention. As shown in FIG. 3, the cell bound has a CIS server 10 to which at least one communication terminal is connected. More specifically, the CIS server 10 is connected to a private branch exchange (PBX) 20, a branch server 30, an Internet phone 50, a mobile communication terminal 60, a wireless transceiver 70 and a satellite antenna 80, which are accessible to a plurality of communication networks: e.g., a public switched telephone network (PSTN) N100, an Internet N200, a wireless subscriber network N300, a satellite communication network N400 and a mobile communication network N500.

For example, the PBX 20 is connected to a plurality of in-plant extension telephones and communicates with outside through the PSTN N100.

The branch server 30 is accessible to the Internet N200 and connected to a plurality of personal terminals 40 such as PC through a hub 31.

The Internet phone 50 may make a call through Internet via an Internet phone gateway (not shown). The Internet phone 50 has a means for compressing, decompressing and transmitting voices according to VoIP protocols.

The mobile communication terminal 60 includes a cellular phone, PCS, PDA, TRS and so on, and communicates through the mobile communication network N500. The wireless subscriber network N300 may communicate in connection to WLL or wireless CATV through the wireless transceiver 70. The satellite communication network N400 is connected to a satellite phone, a satellite Internet terminal and so on (not shown) for communication therethrough.

As described later, the CIS server 10 according to the present invention may communicate through the mobile communication network N500 by use of a mobile communication terminal, through the wireless subscriber network N300 by the wireless transceiver 70, or through the satellite communication network N400 by the satellite antenna 80. The wireless subscriber network N300, the satellite communication network N400 and the mobile communication network N500 are just used as communication means or media according to various communication technologies, as an example for describing embodiments to realize a technical concept of the invention. Thus, it should be understood that the present invention is not limited to those cases, but the whole communication networks including a mobile communication network is inclusively expressed as a ‘wireless communication network’ in the following description and the appended claims. Furthermore, the communication terminals exemplified in the embodiments should be understood to include all of fixed or movable communication terminals which can be commonly adopted in the technical field of the present invention.

According to a preferred embodiment of the present invention, a user uses a wireless LAN terminal such as a notebook 41 equipped with a wireless modem, and is thus accessible to the CIS server 10 by connection to the branch server 30 through an access point 32 which recognizes the wireless modem and exchanges signals.

According to a more preferred embodiment of the present invention, the branch server 30 is provided with an identifier reader 33 for recognizing a user identifier such as an ID card, a fingerprint or an iris. As described later, a user may register his/her own location information and communication terminal information when the identifier reader 33 recognizes an identifier of the user.

3. A CIS Server

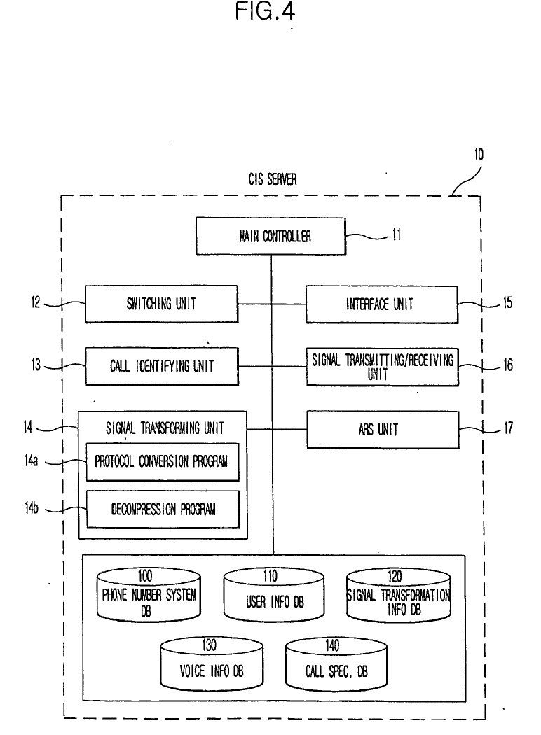

The CIS server 10 collects communication terminal information of users and then transmits it to the CIS relay station C300. In addition, the CIS server 10 receives fittest communication route information from the CIS relay station C300 and then connects a communication line according to the information. FIG. 4 shows a configuration of the CIS server 10.

As shown in FIG. 4, the CIS server 10 includes a main controller 11 for synthetic control of each component, a switching unit 12 for connecting or disconnecting an input/output call signal according to a communication terminal, a call identifying unit 13 for recognizing a caller phone number of the call received from a communication terminal, a signal transforming unit 14 for transforming an input/output signal agreeable to the connected communication terminal for enabling communication, an interface unit 15 physically connected to various communication terminals for interfacing, a signal transmitting/receiving unit 16 for transmitting a call signal according to a fittest communication route and receiving a call signal from an opponent, and an ARS unit 17 for converting digital voice data into analog voice data and then providing it to the connected user.

Preferably, protocol conversion programs 14a for converting a call signal into a protocol corresponding to each communication terminal and various decompression programs 14b such as PCM, ADPCM, ATC and ACELP for compressing and decompressing call signals are loaded in the signal transforming unit 14. In addition, the signal transmitting/receiving unit 16 generates and provides various audible indications such as a dial tone, a calling tone, a busy tone and a warning tone, as described below.

The CIS server 10 works together with various databases: a phone number system DB 100, a user information DB 110, a signal transformation information DB 120, a voice information DB 130 and a call specification DB 140.

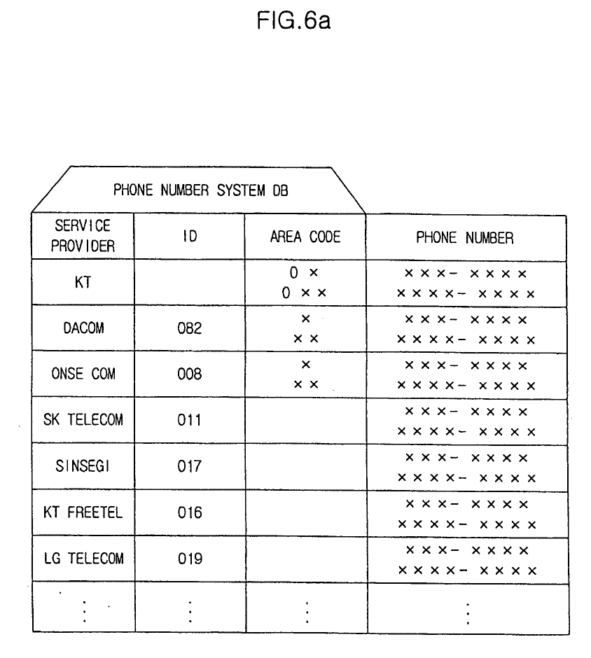

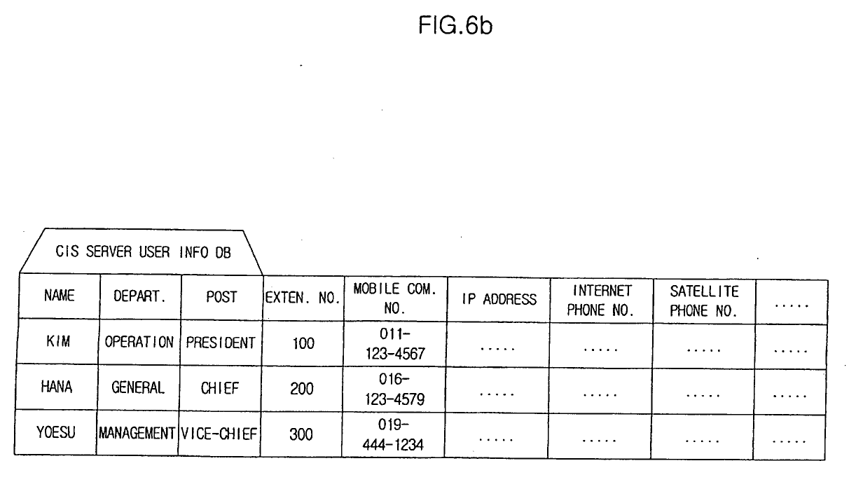

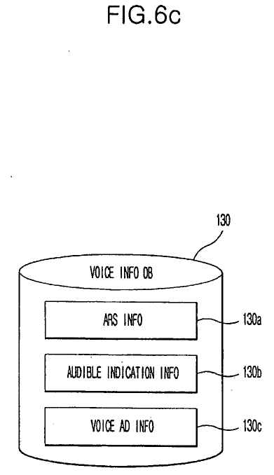

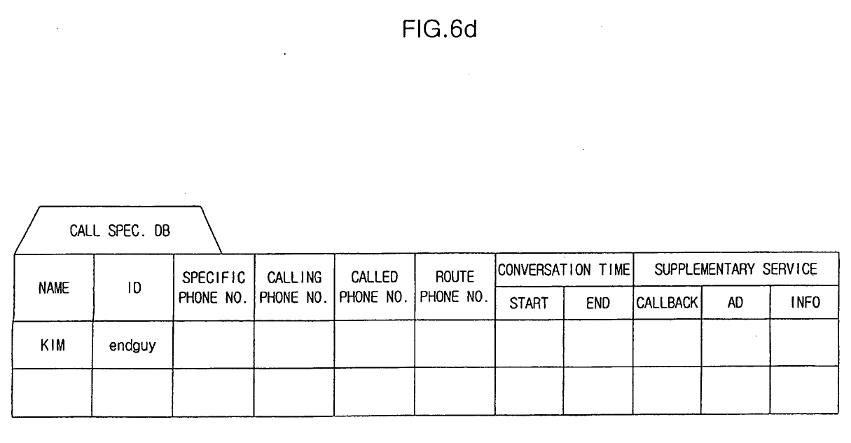

The phone number system DB 100 stores data used for comparing phone numbers input by a caller and a receiver in order to determine whether the phone numbers are appropriate. As shown in FIG. 6a, the data stored in the phone number system DB 100 includes a name of a communication service provider, an ID of a communication service provider, an area code, a type of phone number and so on.

The user information DB 110 stores registration information of users belonging to the cell bound in which the CIS server 10 exists. As shown in FIG. 6b, the registration information includes historical data such as a user name, a department belonged by a user and a post of a user, and phone number data of a communication terminal such as a PBX extension number, a mobile communication phone number, an IP address, an Internet phone number and a satellite phone number.

The signal transformation information DB 120 stores protocol data of various communication terminals for transforming call signals, various digital compression/decompression algorithm data, communication terminal control data and so on.

The voice information DB 130 may include, as shown in FIG. 6c, ARS information 130a required to an audio response system for providing a guidance message to users, various audible indication information 130b such as a dial tone, a calling tone, a busy tone and a warning tone as described above, and voice advertisement information 130c for providing advertisement broadcast to callers as described below.

The call specification DB 140 is a database for recording a call specification of a user who makes a call according to the control of the CIS server 10. As shown in FIG. 6d, information of a communication terminal used for calling, a conversation time and/or supplementary service usage detail are recorded and stored in the call specification DB 140, and they are also sent to CIS relay station C300 so as to be used as a data for imposing a call charge.

The CIS server constructed as above is positioned in each cell bound and then accessed to and controlled by the CIS relay station C300. Now, the CIS relay station is described in detail.

4. A CIS Relay Station and a CIS Relay Server

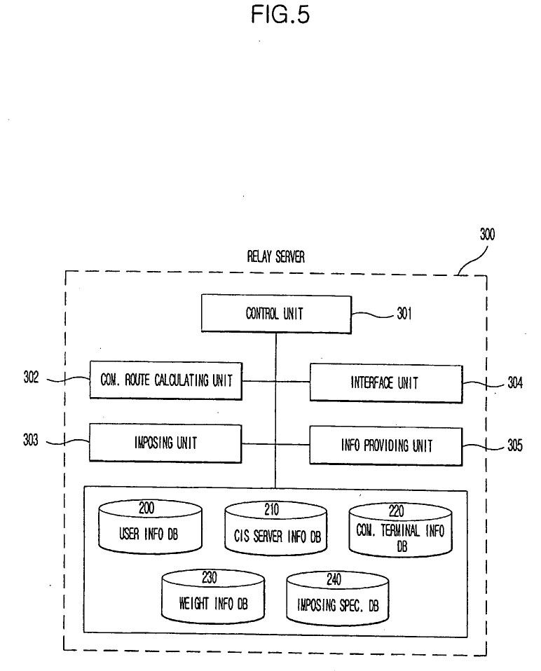

As shown in FIG. 2, the CIS relay station C300 is connected to the CIS server 10 and the network, and preferably to Internet. The CIS relay station C300 includes a web server (not shown) for providing a service web page to users accessed through Internet and providing a web site for user registration/authentication and registration of communication terminal information for new users, and a relay server 300 (see FIG. 5) for calculating and providing a fittest communication route based on the communication terminal information of a user.

The web server executes registration and logging-in of users accessed to the web site through a network and provides common HTML web pages for inputting the communication terminal information. The web server having such functions is already well known in the art, including its various modifications, thus not described in detail.

The relay server 300 is shown in FIG. 5 in detail.

As shown in FIG. 5, the relay server 300 includes a control unit 301 for controlling each unit, a communication route calculating unit 302 for calculating a fittest communication route on the basis of the communication terminal information of a user, an imposing unit 303 for calculating and imposing a call charge according to a call specification of a user, an interface unit 304 physically connected to a network such as Internet for connection to the CIS server 10 in order to perform an interfacing function, and an information providing unit 305 for providing the user information before or during a call.

In addition, the relay server 300 includes databases: a user information DB 200, a CIS server information DB 210, a communication terminal information DB 220, a weight information DB 230 and an imposing specification DB 240.

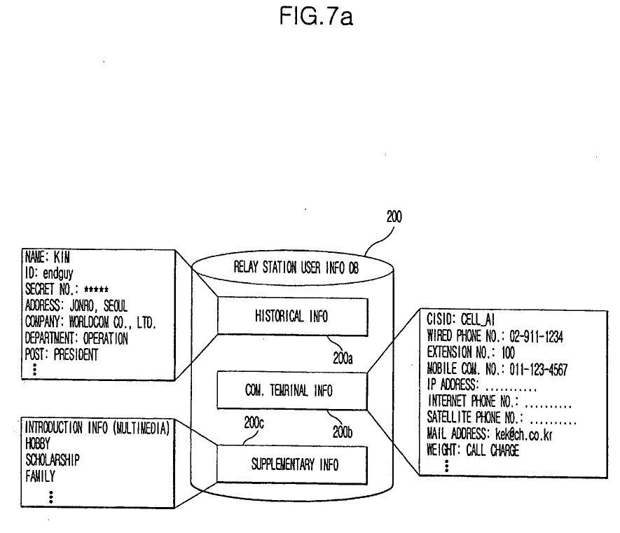

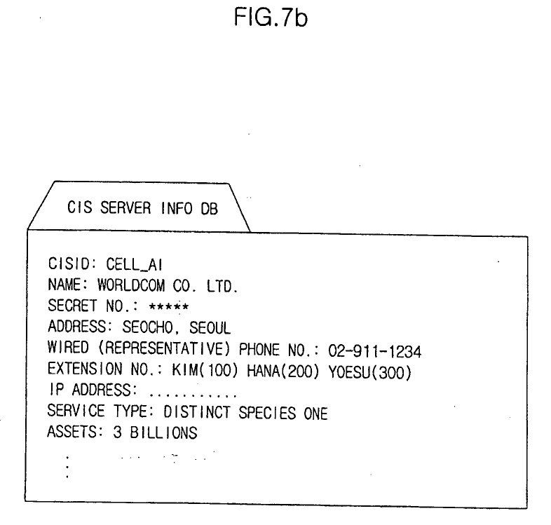

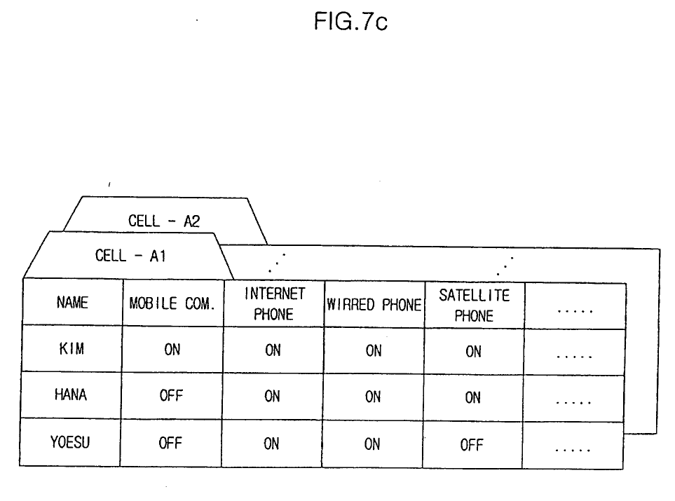

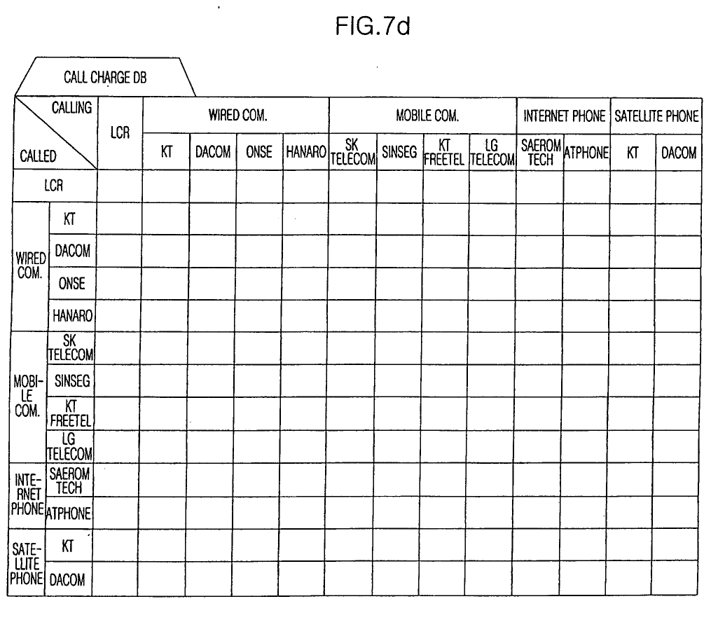

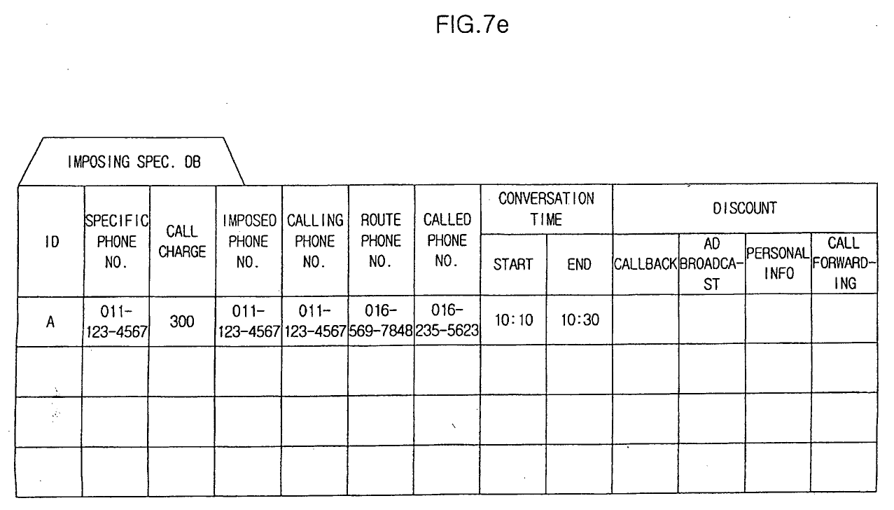

The user information DB 200 may be configured with historical information 200a, communication terminal information 200b and supplementary information 200c as shown in FIG. 7a, as concrete information of a user who is registered for the purpose of using the communication integration service according to the present invention.

The historical information 200a is personal information of a user, which includes historical data such as a name, ID, a secret number, an address, a company, a department and a position.

The communication terminal information 200b is information related to communication terminals peculiar to each user, which includes a CIS ID for identifying a CIS server in a cell bound to which a user belongs, a phone number of a wired telephone, for example adopting a PBX system, representing a cell bound including a CIS server which is a basic communication region of a company or a public institution, an extension number, a mobile phone number of a cellular phone or PCS, an IP address, an Internet phone number, a satellite phone number, a mail address, weight information and so on. Here, the term ‘weight’ is a criterion which is preferentially regarded when a user using the communication integration system according to the present invention selects a communication route. A call charge, speech quality or communication stability can be the weight. For example, in case a user selects the call charge as a weight, the relay server 300 calculates a fittest communication route having a cheapest call charge and then connects a call through the route.

The supplementary information 200c is information other than the historical information and the communication terminal information and includes introduction information for introducing a personal history of a user or other supplementary information such as a hobby, scholarship and a family. According to a preferred embodiment of the present invention, the introduction information configures a history of a user in a format of text, image or moving picture and is provided to an opponent while the user talks over the phone with the opponent. Thus, the user may catch information of the opponent during conversation and it makes the user feel as if he/she makes a picture phone call.

In addition, the CIS server information DB 210 stores information about the CIS server 10 positioned in each cell bound. For example, as shown in FIG. 7b, the CIS server information DB 210 stores a CIS ID for identifying the CIS server, a name of the cell bound to which the CIS server 10 belongs (i.e., a name of a company or group configuring the cell bound), a secret number, an address, a representative phone number of the cell bound, an extension number of each user in the cell bound, an IP address and so on.

The communication terminal information DB 220 stores and updates in real time a state of each communication terminal connected to each CIS server 10 and shows information of the communication terminals which can be used at present by users in each cell bound. As shown in FIG. 7c, the communication terminal information DB 220 shows whether mobile communication terminals, Internet phones, wired phones and satellite phones of users in each cell bound are usable or not. This communication terminal information is obtained when a user accesses the relay server 300 and directly registers the information or when the CIS server 10 collects the communication terminal information and then sends it to the relay server 300, as described later.

The weight information DB 230 stores criterion information such as a call charge, speech quality or communication stability which is used as a criterion for calculating a fittest communication route, and classifies the information for each communication service provider or each communication network. FIG. 7d shows a call charge system for each communication service provider as an example, which may be used as a data for calculating a cheapest communication route.

The imposing specification DB 240 may have data fields in the table shown in FIG. 7e as an example, which contains data obtained by calculating a call charge according to the call details stored in the call specification DB 140 (see FIG. 4). A call charge of a user will be requested according to the imposing specification DB 240.

Now, a method for calculating a fittest communication route using the CIS system according to the present invention and a calling method followed by the calculating method will be described.

5. Registration of Communication Terminal Information

Users using the CIS system according to the present invention are registered in the user information DB 110 of the CIS server 10 and the user information DB 200 of the relay server 300 in advance. Users should register their communication terminal information before attempting a call or answering a call signal received from outside by use of his/her own communication terminal. Such communication terminal information is registered using a personal terminal such as PC 40 (see FIG. 3) or a notebook 41 or a user identifying means 42, or preferably using a communication terminal of the user, for example a mobile communication terminal.

5.1 Registration of Communication Terminal Using a Personal Terminal

A user may notify the relay server 300 of his/her own location and update the communication terminal information by use of the personal terminal 40. For example, by going to the office, a user enters into his/her own cell bound, and at this time the updated communication terminal information informing that the user is now capable of communication should be registered.

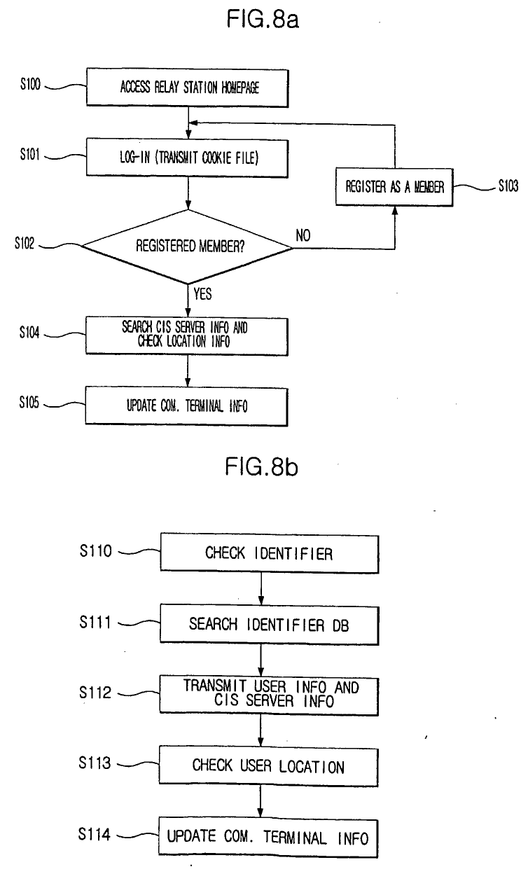

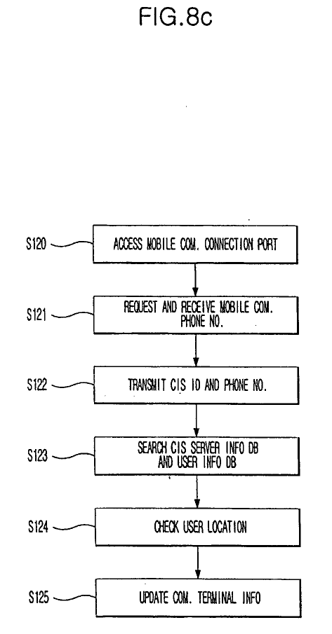

To describe it in more detail with reference to FIG. 8a, a user at first accesses a homepage provided by a web server (not shown) of the CIS relay station C300 by use of his/her own personal terminal 40 (step S100).

Then, the user performs a login procedure by inputting an ID or secret number (step S101). At this time, a cookie file is transmitted from the personal terminal 40 of the user to the relay server 300.

The control unit 301 of the relay server 300 determines whether an accessed user is registered by searching the user information DB 200 (step S102). If the accessed user is not yet registered, the control unit 301 guides the user to register (step S103).

If the accessed user is already registered in the above step, the control unit 301 of the relay server 300 checks information about the CIS server 10 in the cell bound to which the user belongs, by checking CIS server information from the received cookie file and then searching the CIS server information DB 210 (step S104).

After that, the control unit 301 of the relay server 300 extracts communication terminal information of the corresponding user from the user information DB 200 and the CIS server information DB 210. In addition, the control unit 301 determines that the user is capable of communication within the current cell bound and then updates the communication terminal information DB 220 (step S105). According to the present embodiment, if a user transmits the information that he/she is positioned within the cell bound where the CIS server 10 exists to the relay server 300 by use of the personal terminal 40, the relay server 300 determines that all communication terminals operated by the corresponding user are usable within the cell bound, and then updates the communication terminal information DB 220 in consideration of the above fact. In other words, seeing the table shown in FIG. 7c as an example, if recognizing from the cookie file that a user is positioned within the cell bound CELL_Al, the relay server 300 updates data about mobile communication terminal, Internet phone, wired phone and/or satellite phone of the corresponding user that they are all fit for use. At this time, communication terminal types and phone numbers are searched in the user information DB 200.

Such update registration of the communication terminal information can be performed in the same way after accessing the CIS relay station C300 through the access point 32 by using a wireless LAN such as a notebook 41.

Though not specifically shown the drawings, it is also possible that a user directly registers a usable/unusable state for each of his/her own communication terminals. For example, when a user accesses a web server of the CIS relay station C300, the web server proposes specific communication terminal types in HTML pages so that the. user may register the communication terminal information by clicking an appropriate type of the communication terminal.

5.2 Registration of Communication Terminal Information Using a User Identifier

A user positioned in a cell bound may register the communication terminal information by using a user identifier such as an ID card, a fingerprint or an iris. Referring to FIG. 8b showing such a process, the user registers the information by checking a user identifier in the identifier reader 33 (step S110). The identifier reader 33 would be a recognition security device such as a card reader, a fingerprint reader or an iris recognizer.

The information read by the identifier reader 33 is sent to the branch server 30, and the branch server 30 searches a separate identifier DB (not shown) to recognize a user corresponding to the identified information (step S111).

Then, if the branch server sends the user information to the CIS server, the CIS server transmits the user information together with the CIS server information such as a CIS ID to the relay server 300 (step S112). After that, the relay server 300 checks location information of the user from the user information DB 200 and the CIS server information DB 210 as described above (step S113), and then updates the communication terminal information of the corresponding user (step S114).

5.3 Registration of Communication Terminal Information Using a Mobile Communication Terminal

According to the present invention, a user may register the communication terminal information by using his/her own mobile communication terminal 60, as well shown in FIG. 8c.

A user accesses the CIS server 10 by using his/her own mobile communication terminal 60 after entering into a cell bound (step S120). At this time, the interface unit 15 (see FIG. 4) of the CIS server 10 is provided with a port for connection to the mobile communication terminal 60, so the user may complete the access by simply connecting the port. Such a physical access of the mobile communication terminal is not limited to the embodiment, but there can be many modifications: e.g., the user may gain access of the mobile communication terminal by interposing the port with a LAN connected to the hub 31, or the user may access through a wireless extension phone network which can be connected wireless to the mobile communication terminal.

If the mobile communication terminal 60 accesses the CIS server 10, the main controller 11 of the CIS server 10 sends a personal phone number request signal through a communication terminal control data in the signal transformation information DB 120 to the mobile communication terminal 60 and then receives the personal phone number of the mobile communication terminal (step S121).

Subsequently, the main controller 11 of the CIS server transmits information such as ‘CIS ID or personal phone number of mobile communication terminal’ to the relay server 300 (step S122). After that, the relay server 300 searches the user information DB 200 and the CIS server information DB 210 as mentioned above (step S123), checks the location information of the user (step S124) and then updates the communication terminal information DB 230 of the corresponding user (step S125).

5.4 Deletion of Communication Terminal Information

A method for deleting the registered communication terminal information has no concern with the present invention. But, in a concrete embodiment of the present invention, a user may delete the communication terminal information by selecting deletion of the corresponding terminal after accessing the web server with the personal terminal 50 as described above.

As an alternative, in case a user cancels the access by separating the mobile communication terminal 60 from the CIS server 10, the CIS server 10 may delete the usable communication terminal information of the user by transmitting the information to the relay server 300. At this time, the deletion of the communication terminal information can be performed independently or in a bundle. In other words, in case a user separates the mobile communication terminal 60 from the CIS server 10, it is determined that the user leaves the cell bound and then the information for all communication terminals can be deleted. At this time, the deletion means ‘off state’. More preferably, in case a user checks out through the identifier reader 33 by using the user identifier 42, it is determined that the user leaves the cell bound and all of the communication terminal information can be deleted.

Now, the process for connecting a call by calculating a fittest communication route while the communication terminal information of a user is registered is described in detail.

6. Interconnecting a Call between Cell Bounds

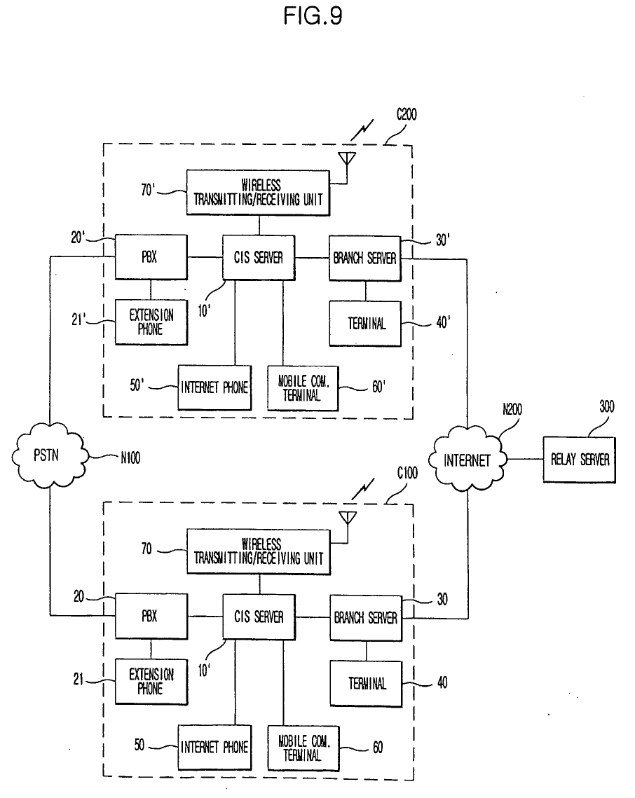

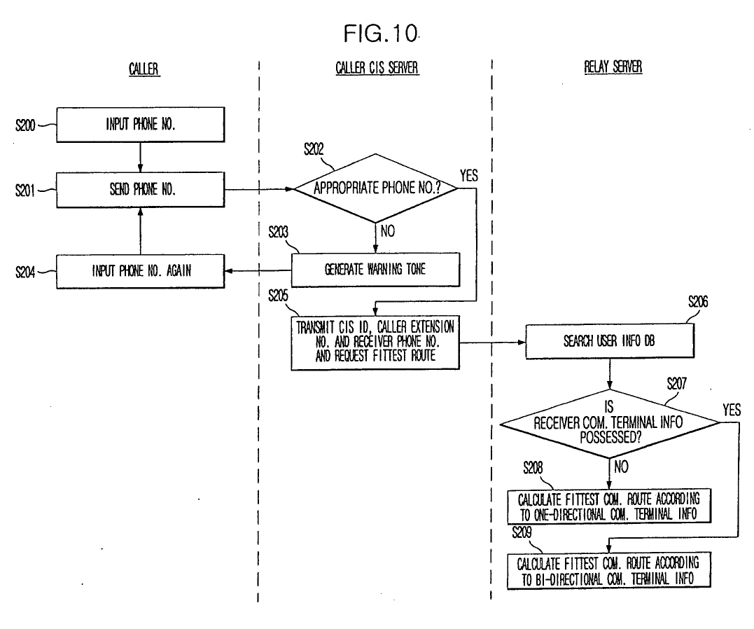

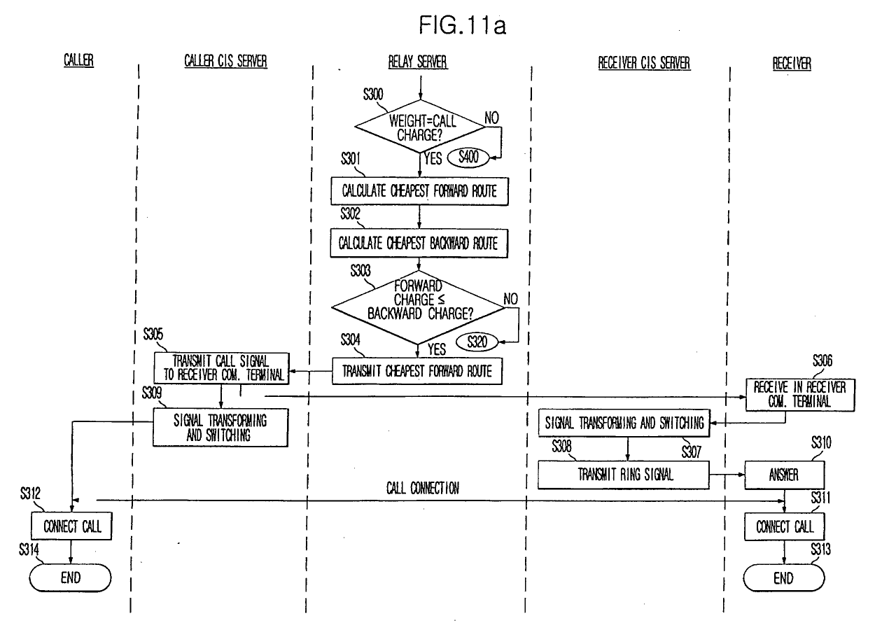

FIG. 9 shows two cell bounds C100 and C200. Here, a case in which a user belonging to one cell bound C100 attempts a call to a user belonging to the other cell bound C200 is described. The call connecting process for this case is shown in FIG. 10.

6.1 Input of Phone Number and Search of Communication Terminal Information

A user (a caller) belonging to the cell bound C100 inputs a phone number of a receiver in order to make a call to an opponent (a receiver) belonging to the cell bound C200 by use of an extension telephone (step S200). At this time, the user may attempt a call by using another communication terminal such as the Internet phone 50, but preferably using the extension telephone 21. If the phone number is input, the PBX 20 will probably transmit the input phone number to an exchange office through PSTN in a common case. However, in the present invention, the PBX 20 transmits the input phone number of the receiver to the CIS server 10 (step S201).

The main controller 11 of the CIS server 10 compares the input receiver phone number with the phone number system DB 100 for determining whether the input phone number is suitable for phone number systems used by communication service providers (step S202). This process is performed in the exchange office in the case of the conventional wired phone. However, in the present invention, since the input phone number is transmitted directly to the CIS server 10 without passing through the exchange office, the CIS server 10 needs to execute the process. In the process, if the input phone number is not appropriate to the phone number system, the signal transmitting/receiving unit 16 generates and outputs, for example, a warning tone stored in the audible indication information DB 130b (see FIG. 6c) of the voice information DB 130 (step S203), forcing the user to input the phone number again (step S204).

On the other hand, if the input receiver phone number is appropriate in the above step, the main controller 11 transmits fittest route calculation request information including ‘CIS ID, a caller extension number and a receiver phone number’ to the relay server 300 of the CIS relay station C300 connected through Internet N200 (step S205).

The control unit 301 of the relay server 300 receiving the fittest route calculation request information searches the user information DB 200 (step S206), and then checks whether the receiver corresponding to the request receiver phone number is a member of the CIS system according to the present invention and his/her communication terminal information is registered in the communication terminal information DB 220 (step S207).

In the above step, if the communication terminal information of the receiver is owned in common, the communication route calculating unit 302 of the relay server 300 calculates a fittest communication route on the basis of the communication terminal information of both the caller and the receiver, i.e. according to bidirectional communication terminal information (step S209). If the communication terminal information of the receiver is not owned in common, the communication route calculating unit 302 calculates a fittest communication route on the basis of the communication terminal information of the caller, i.e. according to one-directional communication terminal information (step S208).

Now, a method for calculating a fittest communication route is described as an example.

6.2 Calculation of a Fittest Communication Route

At first, a normal condition in which the communication terminal information of the receiver is owned in common is described. In this case, the fittest communication route is calculated on the basis of the communication terminal information of both the caller and the receiver. The communication route calculating unit 302 checks information about all communication terminals usable by the corresponding receiver in the communication terminal information DB 220.

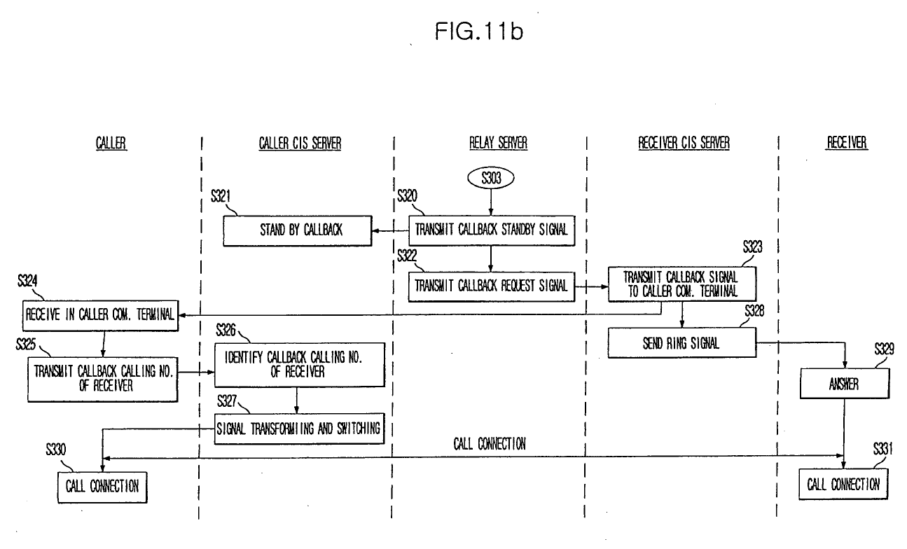

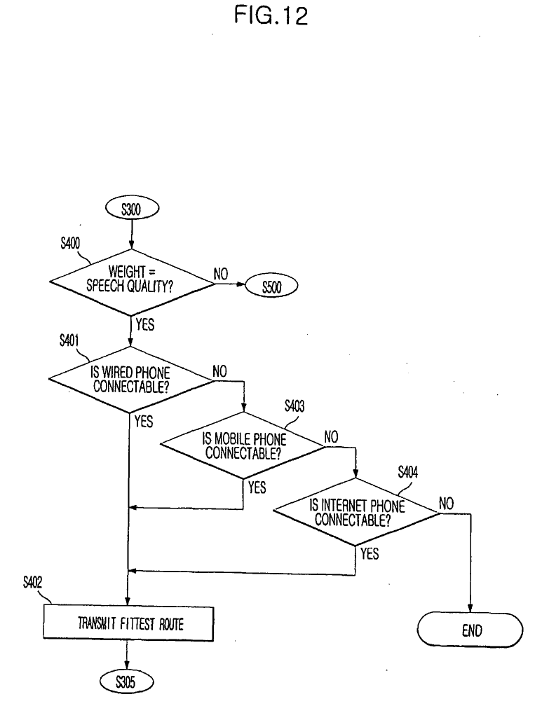

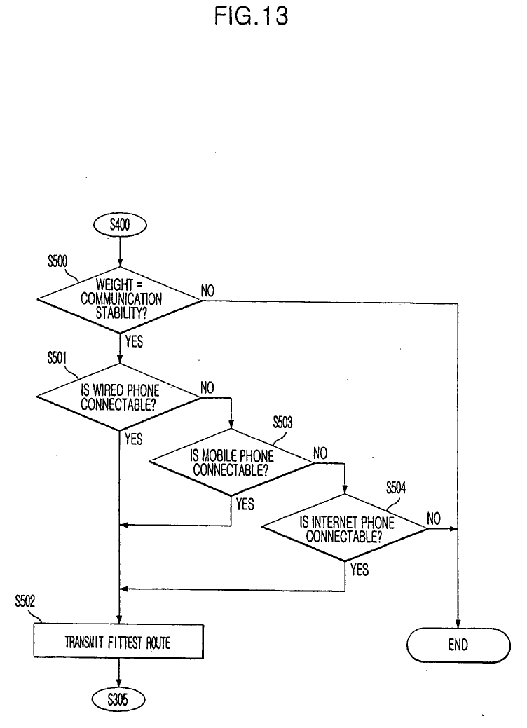

The criterion for calculating the fittest communication route is based on a weight selected by the caller. The weight of the caller previously stored in the user information DB 200 may be selected from a call charge, speech quality, communication stability and so on. In case the weight is a call charge, a cheapest communication route is calculated on the basis of the charge DB (see FIG. 7d) in which call charges for each service provider and each time period are classified. In case the weight is speech quality or communication stability, a route passing through a network having best speech quality or best communication stability is calculated, for example in order of wired phone network→wireless network→Internet. A process of calculating a communication route according to such a weight is respectively shown in FIGS. 11a, 11b, 12 and 13. Here, FIGS. 11a and 11b show the case in which the weigh is a call charge, FIG. 12 show the case in which the weight is speech quality, and FIG. 13 show the case in which the weight is communication stability, respectively. A person skilled in the art will understand that such embodiments are just examples for realizing the present invention, and the communication route can be calculated according to various weights, for example composite weight.

In addition, the term ‘to calculate a fittest communication route’ does not mean to ambiguously calculate a ‘best’ communication route, but mean to calculate a communication route in correspondence to a predetermined weight selected by a caller including a call charge, speech quality and communication stability. It is not an indefinite or obscure term. The weight selected by a caller may present so sufficient criterion to establish just one communication route, thus the route can be fully calculated on the basis of the database exemplified in the embodiments of the present invention. But, since it is different to exemplify all embodiments for explaining such calculating methods and calculating processes and a technical concept of the present invention is not focused completely on the calculating method itself but lies in the idea of ‘attempting a call connection by calculating a fittest communication route on the basis of the information owned in common through the CIS server and the relay station’, the following description contains just several usual examples.

Referring to FIG. 11a, the communication route calculating unit 302 at first searches a weight from the user information DB 200 of the caller in order to determine whether the weight is a call charge (step S300).

If the weight selected by the caller is a call charge, the communication route calculating unit 302 calculates a cheapest forward route from the caller to the receiver (step S301). This is executed by checking information about communication terminals of the caller and the receiver registered in the communication terminal information DB 220 and then referring to the call charge DB (see FIG. 7d) in the weight information DB 230. For example, the caller has three kinds of communication terminals such as a wired phone 21, an Internet phone 50 and a mobile communication terminal 60 and the receiver has three kinds of the communication terminals such as a wired phone 21′, an Internet phone 50′ and a mobile communication terminal 60′, there exists 9 (=3×3) kinds of communicable forward communication routes. The communication route calculating unit 302 calculates a cheapest one among the forward communication routes.

Subsequently, a backward communication route from the receiver to the caller can be calculated as mentioned above (step S302).

If the forward fittest communication route and the backward fittest communication route are calculated, the communication route calculating unit 302 determines whether a charge of the forward fittest communication route is lower than or equal to the backward fittest communication route (step S303). If so, the process proceeds to the step S304 and the call is connected along the forward fittest communication route. Or else, the process proceeds to the step S320 and the call is connected along the backward fittest communication route.

6.3 Call Connection Along Forward Fittest Communication Route

If the charge of the forward fittest communication route is cheaper than that of the backward fittest communication in the step S303, the call is connected in a forward direction. Specifically, the communication route calculating unit 302 of the relay server 300 transmits a calculated forward fittest communication rout to the CIS server 10 of the caller (step S304). At this time, the fittest communication route information includes a communication terminal of the receiver and a specific phone number of the communication terminal.

Subsequently, the signal transforming unit 14 of the CIS server 10 transforms a signal in correspondence to the protocol of the communication terminal of the receiver according to the received fittest communication route information and then the signal transmitting/receiving unit 16 receives a call signal (step S305). For example, in case an extension phone 21′ of the receiver is corresponding to the fittest communication route, the signal transmitting/receiving unit 16 of the CIS server 10 transmits a call signal corresponding to the wired phone number of the user through the PSTN N100, while in case the Internet phone 50′ of the receiver is corresponding to the fittest communication route, the signal transmitting/receiving unit 16 transmits a call signal data packet, which is transformed and compressed in the signal transforming unit 14 according to an Internet phone number of the receiver, via the Internet N200. In addition, in case the fittest communication route is set for the mobile communication terminal 60′ of the receiver, the signal transmitting/receiving unit 16 transmits a call signal corresponding to a mobile communication phone number through the mobile communication network N500 by using the mobile communication terminal 60.

After that, the call signal is received to the corresponding communication terminal of the receiver (step S306), and the receiver answers the call signal by receiving the phone. According to the present invention, the receiver may make an answer by use of the corresponding communication terminal selected by the fittest communication route. For example, a call signal passing through the PSTN N1OO is received in PBX 20′ of the receiver cell bound C200, so the receiver may answer the signal by use of the extension phone 21′ having a corresponding extension number. On the while, an Internet phone call signal passing through Internet N200 is received in the Internet phone 50′ of the receiver, so the receiver may answer the signal using the Internet phone 50′. In addition, a call signal passing through the mobile communication network N500 is directly received. in the mobile communication terminal 60′ of the receiver. Thus, the receiver may answer using just one of the communication terminals such as the extension phone 21′, the Internet phone 50′ and the mobile communication terminal 60′, which receives the call signal.

According to a more preferred embodiment of the present invention, the user may answer all call signals by use of one communication terminal, preferably the wired extension phone 21′, regardless of the communication terminal selected by the fittest communication route. More specifically, if a call signal is received to one communication terminal of the receiver belonging to the cell bound C200 in the step S306, this signal is directly sent to the CIS server 10′ of the receiver. At this time, a signal transforming unit in the receiver CIS server 10′ (identical to the signal transforming unit in the caller CIS server) transforms the received signal into a signal corresponding to the wired extension phone 21′ and at the same time a switching unit (identical to the switching unit in the caller CIS server) switches the corresponding signal so as to be connected to the extension phone 21′ (step S307). In addition, a signal transmitting/receiving unit in the receiver CIS server 10′ (identical to the signal transmitting/receiving unit in the caller CIS server) transmits a ring signal to the extension phone 21′ of the receiver (step S308).

Such signal transforming and switching may happen identically in the CIS server 10 of the caller. In other words, since the call also attempts a call using the extension phone 21, if the fittest communication route is not for a wired phone but for an Internet phone or a mobile communication terminal, the signal transforming unit 14 transforms the call signal into a signal corresponding to the wired phone and at the same time the switching unit 12 switches the communication route of the receiver so as to be connected to the extension phone 12 (step S309).

Subsequently, the receiver responds to the signal by answering the extension phone 21′ (step S310), and then a call is connected by establishing the communication route between the caller and the receiver (steps S311 and S312).

While talking over the telephone, signals according to other communication terminals and routes are transformed and provided into appropriate protocol signals through the signal transforming unit 14, enabling to keep the call connected. A call specification between the caller and the receiver is stored in CIS server 10 and/or 10′. After the call ends (steps S313 and S314), the call specification is sent to the relay server 300 of the CIS relay station C300 for an imposing process of the imposing unit 303 (see FIG. 5), and the imposing result is stored in the imposing specification DB 240.

6.4 Call Connection Along Backward Fittest Communication Route (Callback)

If a charge of the backward fittest communication route is cheaper than that of the forward fittest communication route in the step S303, the process proceeds to the step S320 to make a so-called ‘callback’ along the backward fittest communication route, which is well shown in FIG. 11b.

This callback service is basically caused by differential charges fixed by communication service providers, remarkably in an international telephone communication. The callback service connects a call not from a caller who attempts to connect a call first to a receiver, but from a receiver to a caller to the contrary.

Accordingly, referring to FIG. 11b, if the communication route calculating unit 302 of the relay server 300 calculates a backward fittest communication, i.e. a callback route, a callback standby signal is transmitted to the CIS server 10 of the caller (step S320). This callback standby signal is for requesting the user to stand by a callback signal from the receiver and includes information such as ‘communication terminal of the receiver and a phone number of the communication terminal (i.e., callback calling number)’ calculated according to the fittest communication route.

If receiving the callback standby signal including such information, the main controller 11 of the CIS server 10 stands without attempt to connect the call until a callback signal corresponding to the designated receiver phone number is received (step S321).

At the same time, the communication route calculating unit 302 of the relay sever 300 transmits a callback request signal to the CIS server 10′ of the receiver cell bound C200 (step S322). This callback request signal is for requesting the receiver to connect a call backward to the caller, and includes information such as ‘communication terminal of the opponent caller and a phone number of the communication terminal’. Hereinafter, an initial caller becomes a receiver for receiving a callback signal, while an initial receiver becomes a caller for sending a callback signal. However, the terms ‘caller’ and ‘receiver’ are not reversely defined in the following description but used as they are firstly defined in order to avoid misunderstanding.

Then, the signal transmitting/receiving unit of the receiver CIS server 10′ receiving the callback request signal transmits a call (or, callback) signal to the communication terminal of the opponent caller according to the designated phone number (step S323).

Thus, the communication terminal designated in the caller cell bound C100 receives the call signal (step S324), and a signal including the receiver phone number (i.e., callback calling number) is again transmitted to the CIS server 10 (step S325).

Subsequently, the call identifying unit 13 of the caller CIS server 10 checks whether the received signal contains the receiver phone number, i.e. a callback calling number received in the step S320 (step S326). If so, the signal transforming unit 14 transforms a call signal and the switching unit 12 switches the call as mentioned above so that the call is connected to the extension phone 21 of the caller (step S327).

On the other hand, the signal transmitting/receiving unit of the receiver CIS server 10′ transmitting the call signal in the step S323 also transmits a ring signal to the extension phone 21′ of the receiver (step S328). After that, if the receiver answers the ring signal through the signal transforming and switching processes as mentioned above (step S329), the call is connected between the caller and the receiver (steps S330 and S331).

6.5 Calculation of Fittest Communication Route According to Other Weights and Call Connection Along the Route

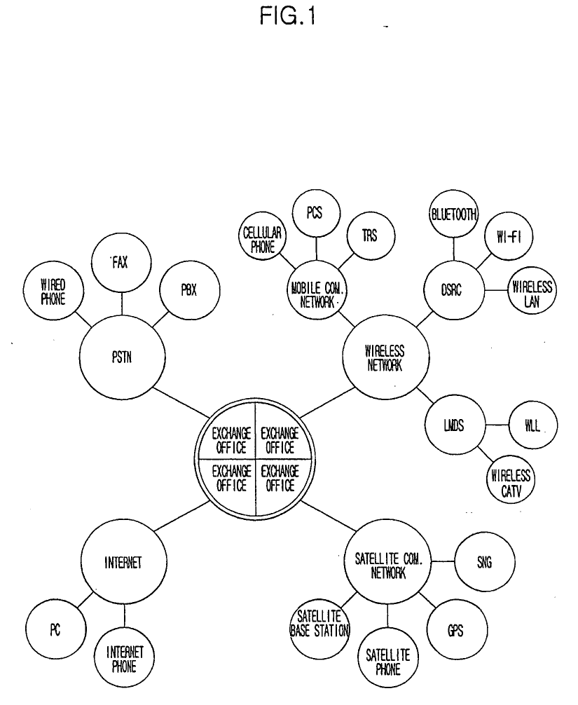

If it is determined in the step S300 of FIG. 1a that a previously selected weight is not a call charge, the process proceeds to the step S400, which is well shown in FIG. 12.

Referring to FIG. 12, if the weight of the caller is not a call charge, the communication route calculating unit 302 of the relay server 300 determines which criterion is the weight, for example speech quality (step S400).

If the weight of the caller is speech quality, the call connection is made according to the priority based on speech quality information of each communication terminal and/or service provider stored in the weight information DB 230 of the relay server 300.

For example, if the speech quality is superior in an order of wired phone→mobile communication terminal→Internet phone, the communication route calculating unit 302 determines at first whether the wired (or, extension) phone 21′ is usable (step S401). If usable, a fittest communication route connected to the wired (or, extension) phone 21′ of the receiver is calculated (step S402).

If the wired phone of the receiver is not usable in the above step, the communication route calculating unit 302 then determines whether the mobile communication terminal 60′ of the receiver is usable (step S403). If usable, a fittest communication route is calculated with regard to the mobile communication terminal 60′.

Furthermore, if both the wired phone 21′ and the mobile communication terminal 60′ of the receiver are not usable, the communication route calculating unit 302 checks whether the Internet phone 50′ of the receiver is usable and then calculates a fittest communication route accordingly (step S404).

The information about the calculated fittest communication route including ‘communication terminal of the receiver and a phone number of the terminal’ is transmitted to the caller CIS server 10 as described in the above-mentioned step S305 so as to connect a call. This process is substantially identical to the above description.

On the other hand, if the weight selected by the caller is not speech quality in the step S400, the process proceeds to the step S500 shown in FIG. 13 in order to determine which criterion is selected as the weight.

Referring to FIG. 13, if the weight of the caller is not speech quality, the communication route calculating unit 302 of the relay server 300 determines whether the weight is another criterion, i.e. communication stability (step S500).

If the weight of the caller is communication stability, the call connection is performed according to the communication stability information of each communication terminal and/or service provider stored in the weight information DB 230 of the relay server 300.

For example, if the communication stability is superior in the order of wired phone→mobile communication terminal→Internet phone, the communication route calculating unit 302 determines at first from the communication terminal information of the receiver whether the wired (extension) phone 21′ is usable (step S501). If usable, the communication route calculating unit 302 calculates a fittest communication route connected to the wired (extension) phone 21′ of the receiver (step S502).

If the wired phone of the user is not usable in the above step, the communication route calculating unit 302 then determines whether the mobile communication terminal 60′ is usable (step S503). If usable, the fittest communication route is calculated based on the mobile communication terminal 60′.

Furthermore, if both the wired phone 21′ and the mobile communication terminal 60′ of the receiver are not usable, the communication route calculating unit 302 checks whether the Internet phone 50′ of the receiver is usable and then calculates a fittest communication route accordingly (step S504).

The information about the calculated fittest communication route including ‘communication terminal of the receiver and a phone number of the terminal’ is transmitted to the caller CIS server 10 as described in the above-mentioned step S305 so as to connect. a call. This process is substantially identical to the above description.

6.6 Calculation of Fittest Communication Route according to One-Directional Communication Terminal Information

If the receiver is not a user of the CIS system according to the present invention or his/her communication terminal information is not owned in common in the step S207 of FIG. 10, the fittest communication route is calculated just based on the communication terminal information of the caller.

Even in this case, by considering which is selected as a weight among a call charge, speech quality and communication stability, the fittest route may be calculated on the basis of the corresponding database. However, though the caller may have various kinds of communication terminals such as a wired phone, a mobile communication terminal and an Internet phone, the receiver may use one kind of communication terminal corresponding to the phone number which is input by the caller. Thus, the route selected in consideration of the weight forwards from one of the caller communication terminals to a predetermined communication terminal of the receiver, In addition, there may exist just forward route, and the callback in a backward direction does not exist.

6.7 Selection of a Plurality of Publicly-Owned Communication Terminals and Imposing

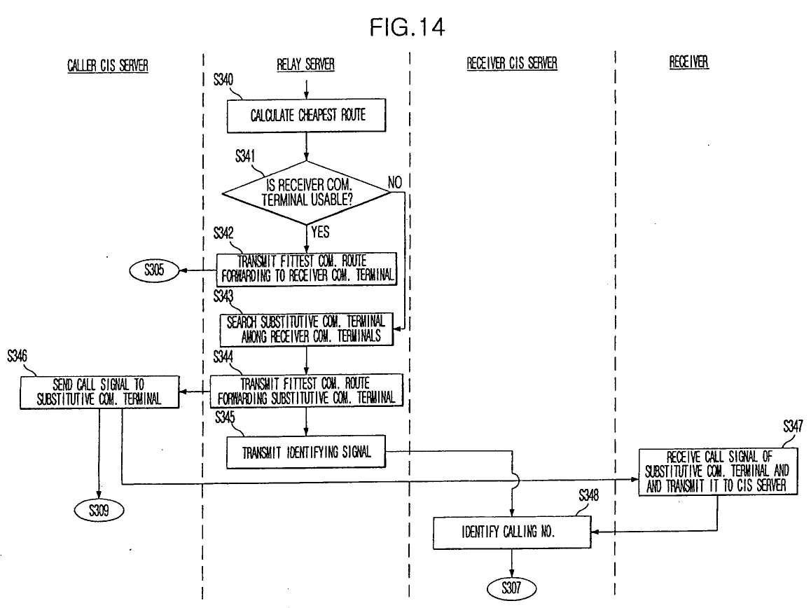

According to the present invention, a caller and a receiver may use in common not only their own communication terminals but also communication terminals of other persons publicly owned in the same cell bound. This may be suitable particularly. in case the communication terminals of the caller and the receiver are not usable, which is well shown in FIG. 14.

For example, if it is determined that the call connection through the mobile communication terminal 60′ of the receiver is most advantageous after calculating the fittest communication route on the basis of a call charge (step S340), the communication route calculating unit 302 of the relay server 300 searches the communication terminal information DB 220 to determine whether the mobile communication terminal 60′ of the receiver is usable (step S341).

At this time, if the mobile communication terminal 60′ of the receiver is usable, the fittest communication route information in which the mobile communication terminal of the receiver is set as a connecting communication terminal is transmitted to the caller CIS server 10 (step S342). Of course, such fittest communication route information includes ‘the connecting communication terminal of the receiver and the connecting phone number’. Subsequently, the CIS server 10 receives a call signal and the call is connected in an identical way to the processes followed after the step S305.

However, if the mobile communication terminal 60′ of the receiver is not usable in the step S341, the communication route calculating unit 302 searches other communication terminals (i.e., mobile communication terminals possessed by other users; hereinafter, referred to as a ‘substitutive mobile communication terminal’) under the same condition in connection to the CIS server 10′ of the cell bound C200 of the receiver (step S343). If it is possible, the communication route calculating unit 302 calculates fittest communication route information using the substitutive communication terminal as a connecting communication terminal and then transmits the information to the CIS server 10 of the caller (step S344). Of course, the fittest communication route information at this time includes ‘the substitutive communication terminal of the receiver and the substitutive phone number’. At the same time, the relay server 300 transmits an identifying signal to the CIS server 10′ of the receiver (step S345). Such an identifying signal includes information such as ‘the calling phone number of the caller’ which will transmit a call signal to the substitutive communication terminal of the receiver and ‘the extension number of the receiver finally connected to the call’.

After that, as described above, the caller CIS server 10 transmits a call signal to the received substitutive communication terminal (step S346), and this call signal is received in the substitutive communication terminal of the receiver and then transmitted to the receiver CIS server 10′ (step S347).

Subsequently, the call identifying unit of the receiver CIS server 10′ which receives the call signal identifies the calling phone number from the received signal and,then checks whether the call signal is in correspondence to the details previously received in the step S345 (step S348). As a result, if the calling phone number is identified, the call is connected through the signal transforming and switching processes as described in the step S307. In other words, the received calling signal is switched to the extension number of the receiver which should be finally connected, so as to connect the call.

Now, the imposing process for the call charge in this case is described in brief. For example, in case a caller A (phone number is 011-123-4567) attempts a call to a receiver B (phone number is 016-235-5623) with the use of a substitutive communication terminal of a user C (substitutive phone number is 016-569-7848), details stated in the imposing specification DB shown in FIG. 7e is as follows: a specific phone number, an imposing phone number, a calling phone number which is a phone number of the caller A (011-123-4567), a route phone number which is a phone number of the user C (016-569-7848) and a receiving phone number which is a phone number of the receiver B (016-235-5623).

Such usage of substitutive phone terminal and route phone number can be identically applied to the callback which is a backward call. This enables a user to select call charges, speech quality and communication stability more diversely by using communication terminals of other persons belonging to the same cell bound in common and using them as a substitutive communication terminal while a communication terminal of a specific receiver is limited.

7. Call Connection to Cell Bound from Outside

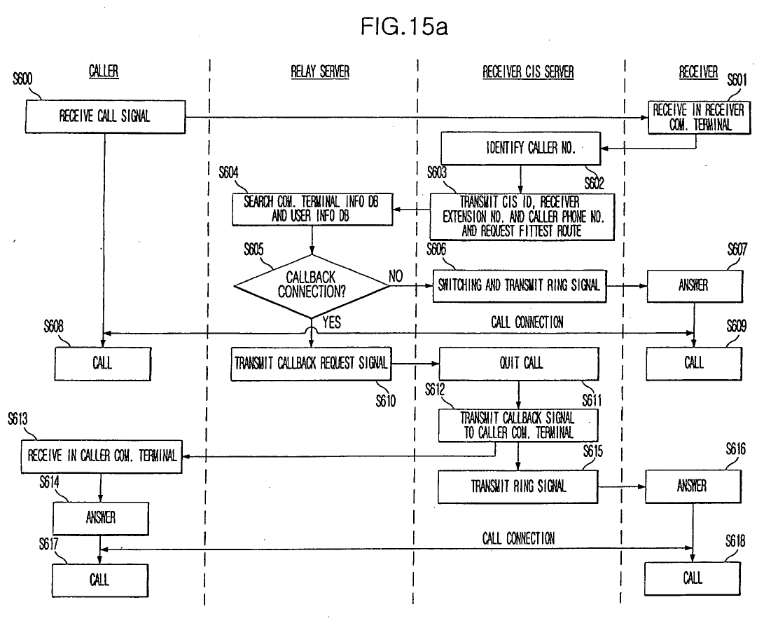

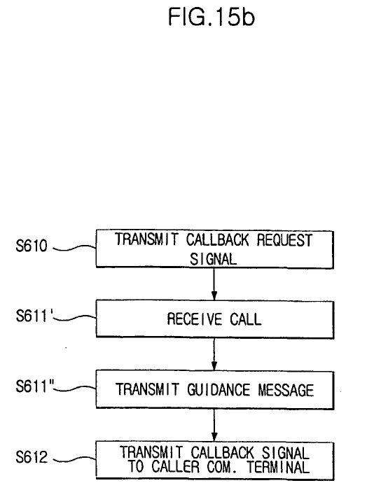

Now, the case of attempting a call to a receiver belonging to a different cell bound while a caller is not a user of the CIS system according to the present invention or leaves from the cell bound is described with reference to FIG. 15a.

At first, the caller inputs a phone number, for example a mobile communication phone number, of the receiver in his/her own mobile communication terminal and then pushes a call button to send a call signal (step S600). This call signal is received to the mobile communication terminal 60 of the receiver cell bound through the mobile communication network N500 (the cell bound in this embodiment is described referring to C100 of FIG. 9 for convenience) (step S601). If the caller inputs a wired phone number or an Internet phone number, the call signal will be received to PBX 20 or the Internet phone 50 through PSTN N100 or Internet N200, respectively.

The signal received in the communication terminal of the receiver is again transmitted to the receiver CIS server 10, and the call identifying unit 13 (see FIG. 4) identifies and checks a calling phone number from the received signal (step S602).

Subsequently, the main controller 11 transmits the received signal information to the relay server 300 without receiving the call signal so as to request calculation of the fittest communication route (step S603). The fittest communication route request includes information such as “the CIS ID of the receiver, the receiver extension number and the phone number of the identified caller’.

The relay server 300 receiving the fittest communication route request searches the user information DB 200, the CIS server information DB 210 and the communication terminal information DB 220 to calculate the fittest communication route according to the weight as mentioned above. At this time, it is also determined whether the fittest communication route is performed using the callback (step S605). Here, if the callback is not required, the communication route is just a one-directional communication forwarding from the caller to the receiver. However, since the one-directional communication is already used by the call connection of the caller, the receiver CIS server 10 transmits a ring signal to the extension phone through the signal transforming and switching processes (step S606), and then the receiver answers the ring signal (step S607) to connect the call (steps S608 and S609).

On the other hand, if it is determined that the callback is the fittest communication route in the step S605, the relay server 300 transmits a callback request signal to the receiver CIS server 10 (step S610). This callback request signal includes information such as ‘caller communication terminal and its phone number’.

According to this embodiment, the call signal received from the caller should be concluded in order to transmit the callback signal from the receiver to the caller. Thus, the signal transmitting/receiving unit 16 of the receiver CIS server 10 disconnects the call signal transmitted from the caller to conclude the call (step S611).

After that, the signal transmitting/receiving unit 16 transmits the callback signal again to the caller communication terminal (step S612), and accordingly the communication terminal of the caller receives the callback signal (step S613) and answers it (step S614).

At the same time, the signal transmitting/receiving unit 16 transmits a ring signal to the extension phone 21 of the receiver (step S615) in order to connect a call between the caller and the receiver (steps S617 and S618).

According to another embodiment of the present invention, an announcement or advertisement message may be transmitted to the caller in the step S611 for concluding the call, which is well shown in FIG. 15b.

In other words, after the relay server 300 transmits the callback request signal to the receiver CIS server 10 (step S610), the signal transmitting/receiving unit 16 of the receiver CIS server 10 receives a call signal of the caller received from the. receiver communication terminal (step S611′). After that, the ARS unit 17 of the CIS server 10 is operated to send a guidance message to the caller communication terminal (step S611″). This guidance message is extracted from the ARS information 130a (see FIG. 6c) of the voice information DB 130, and may include a guidance text such as “ring off and stand by for a while, then the receiver will give a ring”.

More preferably, the ARS unit 17 may give an advertisement message to the caller. This advertisement message data is extracted from the voice advertisement information 130c of the voice information DB 130.

Subsequently, if the caller receiving the guidance message rings off and stand by, the receiver CIS server 10 transmits a callback signal to the communication terminal of the caller (step S612), and the process is proceeded in the same way as the above description.

8. Provision of User Information

According to a preferred embodiment of the present invention, a caller and a receiver may enjoy a call with receiving information about the opponent and viewing it visually before or during the conversation.

In other words, the user information DB 200 of the relay server 300 includes introduction information as the supplementary information 200c. Thus, after receiving the fittest communication route calculation request from the CIS server 10′ (or, 10 in FIG. 9) of the cell bound to which a caller or a receiver belongs and then calculating and providing the fittest communication route, the relay server 300 extracts the introduction information of the caller and the receiver from the user information DB 200 and then transmits the introduction information to the PC terminal 40′ of the receiver and the PC terminal 40 of the caller respectively so that the introduction information is displayed. This introduction information may include not only text but also image or moving picture. Thus, the users may checks the personal information of the opponent before or during the call. Such functions make the users using the CIS system according to the present invention as if they enjoy a video phone.

### INDUSTRIAL APPLICABILITY

As described above, the CIS system and the calling method using the system according to the present invention ensure cheaper call service having better quality because of owning information about all communication terminals of users belonging to a cell bound and calculating the fittest communication route between the caller and the receiver. Furthermore, since the CIS server and the relay server automatically calculate the fittest communication route to connect a call in the present invention, users need not to verify various advantages and effects to select a communication channel path.

In addition, though a communication terminal desired by a receiver is not usable, the present invention enables smooth call by using a substitutive communication terminal connected in the same cell bound as a connecting media. Furthermore, this allows users to have more choices for such as a call charge by using other communication terminals as a substitutive terminal even in a state that the communication terminals of one user are limited and resultantly there are not many choices.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A calling method using a communication integration system including CIS servers (10) configuring a cell bound in connection with a plurality of communication terminals and a plurality of communication networks and a relay server (300) connected to at least two CIS servers, the method comprising the steps of:
(a) transmitting a fittest communication route calculation request signal from the CIS server to the relay server;
(b) the relay server calculating a fittest communication route between users on the basis of a predetermined weight according to the request signal and then providing the fittest communication route to the CIS server; and
(c) the CIS server performing call connection between the communication terminals of the users according to the calculated fittest communication route.

2. A calling method using a communication integration system according to claim 1, further comprising the step of: the user registering communication terminal information of the user in the relay server by using a personal terminal.

3. A calling method using a communication integration system according to claim 1, wherein an identifier reader for reading a user identifier including an ID card, a fingerprint and an iris of the user is installed in the cell bound in which the CIS server is positioned, wherein the method further comprises the steps of:
checking that the user enters into the cell bound by using the identifier reader and then transmitting the information from the CIS server to the relay server; and
the relay server searching communication terminal information of the user from the user information DB previously registered according to the received information and then registering the communication terminal information.

4. A calling method using a communication integration system according to claim 1, further comprising the steps of:
the user making a mobile communication terminal access the CIS server;
the CIS server checking peculiar information of the accessed mobile communication terminal and then transmitting the peculiar information to the relay server; and
the relay server searching communication terminal information of the user from the user information DB previously registered according to the received peculiar information and then registering the information.

5. A calling method using a communication integration system according to claim 1, wherein the communication terminal is at least one selected from a wired extension phone using PBX, a mobile communication terminal and a satellite phone.

6. A calling method using a communication integration system according to claim 1, wherein the weight is at least one selected from a call charge, speech quality and communication stability.

7. A calling method using a communication integration system including CIS servers (10) configuring a cell bound in connection with a plurality of communication terminals and a plurality of communication networks and a relay server (300) connected to at least two CIS servers, the method comprising the steps of:
(a) a caller, who belongs to in one cell bound, inputting a phone number of one of the communication terminals of a receiver, who belongs to another cell bound, by use of one of the communication terminals, and then attempting a call;
(b) the caller CIS server transmitting fittest communication route request information including the input phone number to the relay server;
(c) the relay server calculating a fittest communication route between the caller and the receiver on the basis of a weight determined by searching user information, CIS server information and communication terminal information which are previously registered, and then transmitting the fittest communication route to the caller CIS server;
(d) the caller CIS server sending a call signal to the communication terminal of the receiver along the received fittest communication route; and
(e) connecting a call between the caller and the receiver when the receiver answers the call signal.

8. A calling method using a communication integration system according to claim 7, further comprising the step of: the CIS server switching the call into a wired extension number of the caller.

9. A calling method using a communication integration system according to claim 7, wherein the step (e) includes the steps of:
transmitting the call signal, transmitted from the caller CIS server and then received in the communication terminal of the receiver, to the receiver CIS server; and
the receiver CIS server switching the received call signal into a wired extension phone of the receiver to connect a call.

10. A calling method using a communication integration system according to claim 7, wherein the call between the caller and the receiver is connected via a substitutive communication terminal of other user provided in the cell bound to which the caller and the receiver belong.

11. A calling method using a communication integration system according to claim 10, further comprising the steps of:
the relay server determining whether the communication terminal of the receiver is usable from receiver communication terminal information;
the relay server searching substitutive communication terminals of other users belonging to the receiver cell bound from user information DB and CIS information DB when the communication terminal of the receiver is not usable;
the relay server transmitting fittest communication route information including information about the substitutive communication terminal to the caller CIS server and at the same time transmitting identifying information to the receiver CIS server;
the caller CIS server sending a call signal to the substitutive communication terminal according to the fittest communication route information;
transmitting the call signal received by the substitutive communication terminal to the receiver CIS server;
the receiver CIS server identifying a calling phone number from the received call signal according to the identifying information; and
connecting a call to the corresponding receiver according to the identified calling phone number.

12. A calling method using a communication integration system including a CIS server (10) configuring a cell bound in connection with a plurality of communication terminals and a plurality of communication networks and a relay server (300) connected to the CIS server, the method comprising the steps of:
(a) a caller, who does not belong to the cell bound, inputting a phone number of one of the communication terminals of a receiver who belongs to the cell bound, and then sending a call signal;
(b) transmitting the call signal received by the communication terminal of the receiver to the CIS server;
(c) the CIS server transmitting fittest communication route request information including a phone number of the caller to the relay server;
(d) the relay server calculating a backward fittest communication route from the receiver communication terminal to the caller communication terminal according to a weight based on a call charge by searching user information and communication terminal information which are previously registered;
(e) determining whether a call charge of the fittest communication route is cheaper than that of a communication route forwarding from the caller to the receiver, and then if so, the relay server transmitting a callback request signal to the CIS server;
(f) the CIS server, which receives the callback request signal, concluding the call received from the caller;
(g) the CIS server, which concludes the call, sending a call signal to the communication terminal of the caller; and
(h) the CIS server connecting a call between the caller and the receiver when the caller answers the call signal.

13. A calling method using a communication integration system according to claim 12, wherein the step of concluding a call includes the steps of:
receiving a call signal of the caller in the receiver communication terminal;
providing a guidance message from the CIS server to the caller communication terminal; and
concluding the call after the caller receives the guidance message.

14. A calling method using a communication integration system of claim 12, further comprising the step of: the relay server providing personal information of the opponent to a personal terminal of the caller and/or the receiver.

15. A communication integration system comprising:
a CIS server (10) connected to a plurality of communication terminals and a plurality of communication networks to configure a cell bound and performing call connection through the networks; and
a relay server (300) connected to at least two CIS servers to own information of the communication terminals connected to the CIS servers in common,
wherein, when the CIS server transmits a fittest communication route calculation request to the relay server, the relay server calculates and provides a fittest communication route between a caller and a receiver on the basis of a weight predetermined by a communication route calculating unit (302) and then the CIS server performs call connection between the communication terminals along the calculated fittest communication route.

16. A communication integration system according to claim 15, wherein the CIS server includes:
a main controller (11) for controlling each component;
a switching unit (12) for connecting or disconnecting a call signal input to or output from the CIS server according to communication terminals;
a call identifying unit (13) for receiving the call signal received in the communication terminal from outside and then identifying a calling phone number;
a signal transforming unit (14) for transforming and outputting the input/output call signal to be agreeable to the connected communication terminal; and
a signal transmitting/receiving unit (16) for transmitting a call signal to outside along the fittest communication route and receiving a call signal from outside.

17. A communication integration system according to claim 15, wherein the communication terminal is at least one selected from a wired extension phone using PBX, a mobile communication terminal and a satellite phone.

18. A communication integration system according to claim 15, wherein the relay server owns the communication terminal information in common when a user accesses the relay server through Internet and then registers and stores the communication terminal information of the user.

19. A communication integration system according to claim 15, wherein, when a mobile communication terminal of a user is connected to the CIS server, the communication terminal information of the user is registered by transmitting information of the mobile communication terminal to the relay server.

20. A communication integration system according to claim 15, wherein an identifier reader (33) for reading a user identifier including an ID card, a fingerprint and an iris of the user is installed in the cell bound, and the communication terminal information is registered by transmitting user information identified by the identifier reader from the CIS server to the relay server.

21. A communication integration system according to claim 15, wherein the relay server includes an information providing unit (305) for transmitting and providing user information to a personal terminal connected to Internet so that a user in the cell bound may check information of the opponent during conversation.

22. A calling method using a communication integration system of claim 1, further comprising the step of: the relay server providing personal information of the opponent to a personal terminal of the caller and/or the receiver.

23. A calling method using a communication integration system of claim 7, further comprising the step of: the relay server providing personal information of the opponent to a personal terminal of the caller and/or the receiver.
